(19) United States
(12) Patent Application Publication
(10) Pub. No.: US 2002/0116339 A1
(43) Pub. Date: Aug. 22, 2002

(54) License verifying system and method of verifying software license

(76) Inventor: Kuo-Liang Lin, Hsin-Chuang (TW)

Correspondence Address: J.C. Patents, Inc., Suite 114, 1340 Reynolds Ave., Irvine, CA, 92614, US

(21) Appl. No.: 09/781,751

(22) Filed: Feb. 12, 2001

(51) Int. Cl. G06F 17/60

(52) U.S. Cl. 705/59; 380/44

(57) ABSTRACT

A license verifying system includes an application, a random code generating circuit, and a random code verifying module. Activated by a control variable, the application provides a random code parameter, which is first transmitted to the random code verifying module, and then, through an I/O bus, to the random code generating circuit. The random code generating circuit generates a corresponding random code upon receipt of the random code parameter, wherein the random code is afterward transmitted back to the random code verifying module for verification. A method of verifying a software license includes steps of providing a random code parameter, transmitting the random code parameter to a random code verifying module, transmitting the random code parameter to a random code generating circuit through an I/O bus, generating a corresponding random code, and verifying the random code.

### BACKGROUND OF THE INVENTION

1. Field of Invention

The present invention relates to a license verifying system. More particularly, the present invention relates to a portable software license verifying system, and a method of verifying software licenses.

2. Description of Related Art

The development of computer applications has grown rapidly in the last decade in response to the significant improvements of computer hardware. Computers, including software applications and hardware, have been used broadly in almost all fields for handling tasks more complicated than ever. Accordingly, software development has become one of the major trends of high-tech industries. Like any other high-tech industries, software development also requires a huge amount of capital, and expensive manpower for developing newer and more useful software applications. However, as opposed tomost industrial products, software applications are much easier to be illegally copied, duplicated, or pirated. Piracy does not only cause damages to the profits of software companies, furthermore, it seriously discourages companies from further investing in this growing business. Therefore, without a reliable license verifying system or method, the growth of software industry is likely to be suppressed by piracy.

Hence, besides attempting to develop better software applications, software companies also struggle on improving the security ability of existing license verifying systems. Conventionally, software applications require users to enter passwords or series numbers, which normally come from manufacturers along with applications, upon installation or first-time execution of the applications. Yet, like software applications, a password or a series number can also be illegally spread. As a result, this conventional software license verifying system barely provides the software industry with any protection.

License verification systems of some software applications further require a hardware key, a packaged simple circuit that is attached to an I/O port, for providing a constant checking code. A hardware key provides more protection than a password or a serial number does. However, the limitation of variation of security checking codes limits the protection provided by a hardware key. Hence, a better and more reliable license verifying system, and method are needed to further protect software applications from unlicensed usage.

### SUMMARY OF THE INVENTION

Accordingly, one object of the present invention is to provide a license verifying system containing a random code verifying module, and a random code generating circuit for effectively preventing unlicensed usage of software applications.

A second object of this invention is to provide a license verifying method including employing a random code generating circuit, and a portable random code verifying module, to prevent unlicensed usage of software applications.

To achieve these and other advantages and in accordance with the purpose of the invention, as embodied and broadly described herein, the invention provides a license verifying system including an application, a random code generating circuit, and a random code verifying module. Activated by a control variable, the application first provides a random code parameter, which is first transmitted to the random code verifying module, and then passes through an I/O bus, to the random code generating circuit. The random code generating circuit generates a corresponding random code upon receipt of the random code parameter, wherein the random code is afterward transmitted back to the random code verifying module for verification. The invention also provides a method of verifying a software license, wherein the method includes providing a random code parameter, transmitting the random code parameter to a random code verifying module, transmitting the random code parameter to a random code generating circuit through an I/O bus, generating a corresponding random code, and verifying the random code.

In the preferred embodiment of this invention, the random code verifying module is a portable software application, so it can be implanted into other software applications easily.

In this invention, the license verifying system combines a software verifying module, and a random code generating circuit, so it provides sufficient protection to software companies to prevent their products from unlicensed usage.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide further understanding of the invention, and are incorporated in and constitute a part of this specification. The drawings illustrate embodiments of the invention and, together with the description, serve to explain the principles of the invention. In the drawings,

FIG. 1 is a schematic block diagram of a license verifying system according to a preferred embodiment of the invention;

FIG. 2 is a flowchart of a method of verifying software license according to the embodiment of this invention;

FIG. 3 is a schematic block diagram of a license verifying system according to another embodiment of this invention;

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

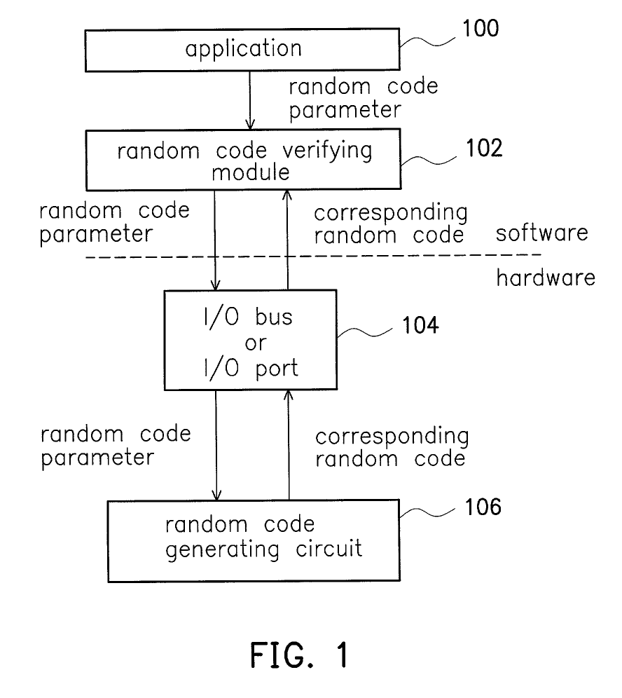

The license verifying system of this invention is shown in FIG. 1.

The license verifying system of the invention includes two parts: software which includes an application 100 and a random code verifying module 102, and hardware, including an I/O bus or I/O port 104 and a random code generating circuit 106.

A programmer can select any factor as a control factor without understanding the details of the random code verifying module 102. For example, a command for executing a key step of the application 100, or the end of evaluation period of the application 100 can be chosen as a control factor for activating the license verifying system of the invention. If verification of the required license is obtained, users can continue to use the application 100. Otherwise, the license verifying system of the invention will, with proper warning or notice, terminate the execution of the application 100.

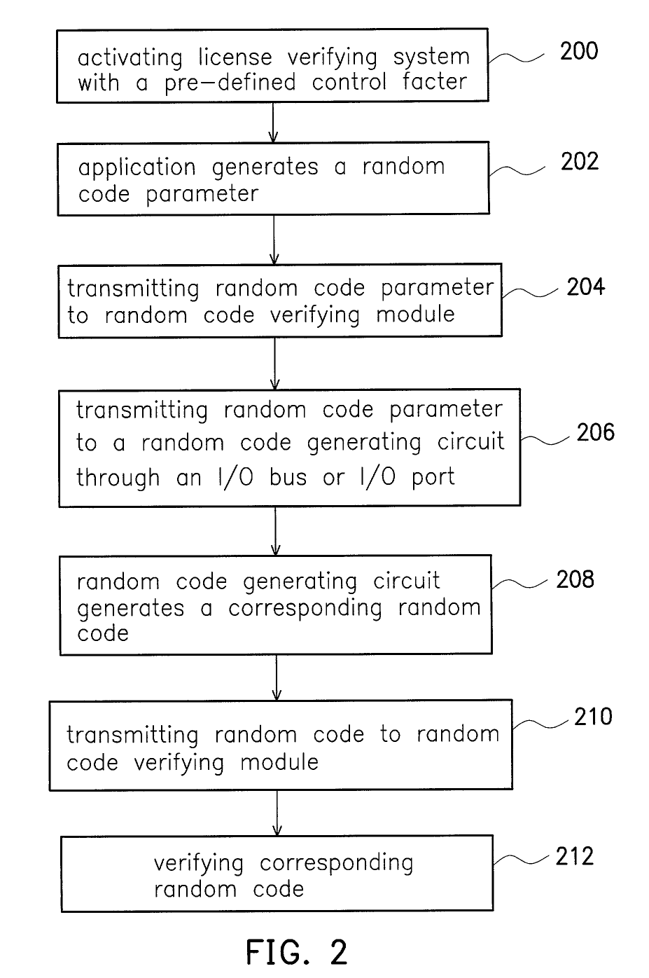

As referring to FIG. 2, a method of the invention for verifying software license by using the license verifying system of FIG. 1 is shown.

Firstly, as in Step 200, once a pre-defined value for the control factor is reached, the license verifying system of the invention is activated. In Steps 202 and 204, the application first generates a random code parameter, and, the random code parameter is then transmitted to the random code verifying module 102. In Step 206, the random code parameter is transmitted, through an I/O bus or I/O port 104, to the random code generating circuit 106. In Step 208, the random code generating circuit 106 generates a corresponding random code by applying a default transfer function, upon receipt of the random code parameter. In Step 210, the corresponding random code is transmitted to the random code verifying module 102 through the I/O bus or I/O port 104. The random code verifying module 102 then checks the received random code by referring to the previously received random code parameter, and the default transfer function, in Step 212.

The random code generating circuit 106 of FIG. 1 can be a stand-alone device, or part of other interface circuits. The random code generating circuit 106 further includes a programmable logic device (PLD) for keeping the default transfer function, wherein the transfer function is modifiable. Upon receipt of a random code parameter, the random code generating circuit applies the default transfer function on the random code parameter for generating a corresponding random code. The random code is then transmitted to the random code verifying module 102 through the I/O bus or I/O port 104 for verification. Because the random code generating circuit 106 uses a programmable PLD for keeping the default transfer function, the default transfer function can be modified through a set of data lines. Therefore, the modifiable transfer function of the invention provides an application more protection from unlicensed usage.

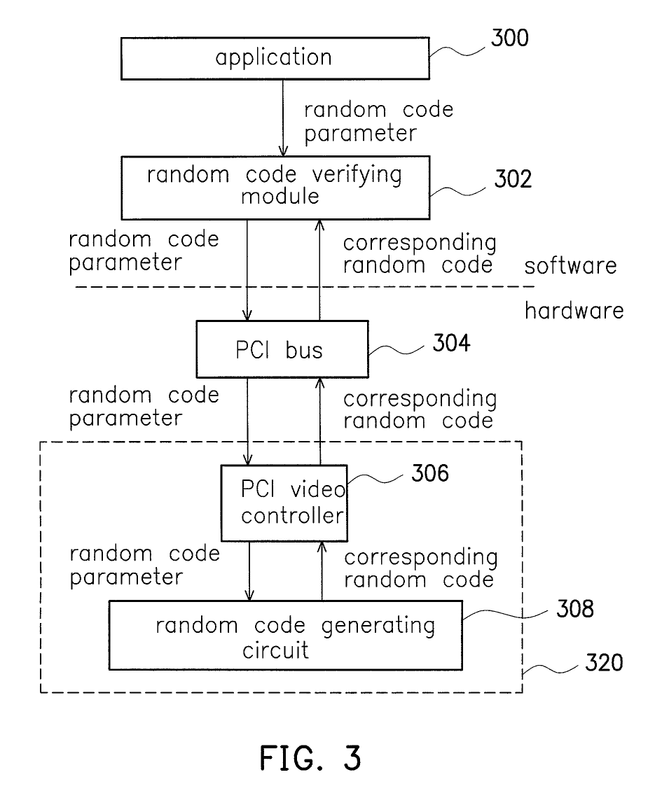

FIG. 3 shows another preferred embodiment of the invention.

The license verifying system of FIG. 3 also includes a software portion and a hardware portion. The software portion includes an application 300 and a random code verifying module 302, and the hardware portion includes a PCI bus 304, a PCI video controller 306 and a random code generating circuit 308.

As in the previous embodiment, a programmer can select any factor as a control factor without understanding the details of the random code verifying module 302. For example, a command for executing a key step of the application 300, or the end of evaluation period of the application 300 can be chosen as a control factor for activating the license verifying system of the invention. If verification of the required license is obtained, users can continue to use the application 300. Otherwise, the license verifying system of the invention will, with proper warning or notice, terminate the execution of the application 300.

The random code generating circuit 308 is a part of a PCI video interface card 320, whereas the random code generating circuit 106 of previous preferred embodiment is a stand-alone circuit. Therefore, the random code parameter from random code verifying module 302 is first transmitted through the PCI bus 304 to the PCI video controller 306 of the PCI video interface card 320, and then, to the random code generating circuit 308 through some on-board data lines. Similarly, after a corresponding random code is generated by the random code generating circuit 308, it is sent through the on-board data lines to the PCI video controller 306, and then transmitted to the random code verifying module 302 for verification through the PCI bus 304. The PLD of the random code generating circuit 308 can be ISPLSI2032E chip, or any other programmable device having similar functionality.

Basically, the application can provide an unlimited number of random code parameters as long as the hardware is supportive. The random code generating circuit with supportive capability can generate an unlimited number of corresponding random codes. However, to try to maintain a reasonable manufacturing cost and acceptable efficiency, a limited number of random codes are preset. The number of valid random codes depends on the number of data lines connecting the PLD. For example, if there are m data lines connect the PLD and the random code generating circuit, the maximum data that can be inputted to or outputted from the PLD is m bits. Then, assuming only the data (n) out of m data lines is read by the transfer function for the purpose of generating a corresponding random code, the random code generating circuit has a capability of generating 2ⁿ different random codes, wherein each random code can vary by 2^{(m-n)} corresponding random codes for output. The random code verifying module contains information regarding the transfer function, so it is capable of validating the corresponding random code from the random code generating circuit. Since the transfer functions kept on the random code generating circuit and the random code verifying module are modifiable, they can be updated by service people periodically or aperiodically so as to provide effective protection.

The transfer function kept on the PLD can be updated through some external data lines, and the random code verifying module can be updated by an ordinary software upgrade.

The I/O bus or I/O port of the invention can vary according to actual availability of hardware, such as a serial port or a parallel port, and is not limited to a PCI bus or video interface.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A license verifying system comprising:
an application, further comprising a random code verifying module; and
a random code generating circuit.

2. The license verifying system of claim 1, wherein the application provides a random code parameter according to a control factor.

3. The license verifying system of claim 2, wherein the control factor is a designated period.

4. The license verifying system of claim 2, wherein the random code generating circuit receives the random code parameter through an I/O bus, and accordingly generates a corresponding random code.

5. The license verifying system of claim 4, wherein the random code verifying module receives the corresponding random code through the I/O bus.

6. The license verifying system of claim 1, wherein the I/O bus includes a PCI bus.

7. A license verifying system comprising:
an application, providing a random code parameter according to a control factor;
a random code generating circuit, receiving the random code parameter through an I/O bus, and thereafter generating a corresponding random code; and
a random code verifying module, receiving the corresponding random code through an I/O bus, and thereafter verifying the corresponding random code.

8. The license verifying system of claim 7, wherein the control factor is a designated period.

9. The license verifying system of claim 7, wherein the I/O bus includes a PCI bus.

10. A method for verifying the software license of an application, comprising steps of:
selecting a control factor of an application, wherein a default value of the control factor activates the application to provide a random code parameter;
transmitting the random code parameter through an I/O bus to a random code generating circuit, wherein the random code generating circuit accordingly generates a corresponding random code; and
transmitting the corresponding random code through the I/O bus to the application for verification.

11. The method of claim 10, wherein the application further comprises a random code verifying module.

12. The method of claim 11, wherein the step of transmitting the random code parameter further comprises step of:
transmitting the random code parameter to the random code verifying module; and
transmitting the random code parameter to the random code generating circuit from the random code verifying module through the I/O bus.

13. The method of claim 11, wherein the corresponding random code is verified by the random code verifying module.

14. The method of claim 10, wherein the I/O bus includes a PCI bus.

15. A method for verifying the software license of an application, wherein the application further comprises a random code verifying module, the method comprising steps of:
selecting a control factor of the application, wherein a default value of the control factor activates the application to provide a random code parameter;
transmitting the random code parameter to the random code verifying module;
transmitting the random code parameter through an I/O bus to a random code generating circuit;
generating a corresponding random code by using the random code generating circuit with reference to the random code parameter, and a transfer function; and
transmitting the corresponding random code through the I/O bus to the random code verifying module for verification.

16. The method of claim 15, wherein the I/O bus includes a PCI bus.

17. A license verifying system comprising:
a portable random code verifying module;
an I/O interface; and
a random code generating circuit, wherein the random code verifying module receives a random code parameter from an application and transmits the random code parameter through the I/O interface to the random code generating circuit, and wherein the random code generating circuit receives the random code parameter and accordingly generates a corresponding random code, and wherein the corresponding random code is transmitted through the I/O interface to the random code verifying module.

18. The license verifying system of claim 17, wherein the I/O interface includes a PCI bus.

19. The license verifying system of claim 17, wherein the I/O interface includes a serial port.

20. The license verifying system of claim 17, wherein the random code generating circuit further comprises a programmable logic device.

21. The license verifying system of claim 17, wherein the random code generating circuit stores a transfer function, wherein the transfer function is updated through a plurality of external data lines.
